(19) United States
(12) Patent Application Publication
(10) Pub. No.: US 2008/0270374 A1
(43) Pub. Date: Oct. 30, 2008

(54) METHOD AND SYSTEM FOR COMBINING RANKING AND CLUSTERING IN A DATABASE MANAGEMENT SYSTEM

(76) Inventors: Chengkai Li, Urbana, IL (US); Lipyeow Lim, Hawthorne, NY (US); Haixun Wang, Irvington, NY (US); Min Wang, Cortlandt Manor, NY (US)

Correspondence Address: DUKE W. YEE, YEE & ASSOCIATES, P.C., P.O. BOX 802333, DALLAS, TX, 75380, US

(21) Appl. No.: 11/740,090

(22) Filed: Apr. 25, 2007

(51) Int. Cl. G06F 17/30

(52) U.S. Cl. 707/5; 707/E17.017

(57) ABSTRACT

A system for combining ranking and clustering in a query. Bit vectors are intersected on Boolean attributes resulting in a vector. Two summary grids are constructed by intersecting bit vectors on clustering and ranking attributes. The vector is intersected with each summary grid to obtain a filtered clustering and ranking grid. An algorithm is applied on the clustering grid to obtain clusters. Vectors associated with buckets in the clusters are intersected resulting in one vector for each cluster. The vector corresponding to each cluster is intersected with the ranking grid to obtain a modified grid. Buckets are pruned according to bounds of each bucket in the modified grid and a predetermined number to obtain candidate buckets containing the predetermined number of data. The data are retrieved and a ranking score is calculated. The top predetermined number of data are sorted according to ranking scores and a result is returned.

### BACKGROUND OF THE INVENTION

1. Field of the Invention

The present invention relates generally to an improved data processing system. More specifically, the present invention is directed to a computer implemented method, system, and computer usable program code for combining ranking and clustering of data in a query search to obtain a result in a database management system.

2. Description of the Related Art

Today, most computers are connected to some type of network. A network allows a computer to share information with other computer systems. The Internet is one example of a computer network. The Internet is a global network of computers and networks joined together by means of gateways that handle data transfer and the conversion of messages from a protocol of the sending network to a protocol used by the receiving network. On the Internet, any computer may communicate with any other computer with information traveling over the Internet through a variety of languages, also referred to as protocols. The Internet uses a set of protocols called Transmission Control Protocol/Internet Protocol (TCP/IP).

The Internet has revolutionized communications and commerce, as well as, being a source of both information and entertainment for end users. As a result, an end user may submit a database query search over the Internet to receive requested information. However, the Boolean semantic of a structured query language (SQL) query may result in information overload. That is, an SQL query may return so many answers that the end user may find it difficult to understand and/or analyze the results. Currently, “ranking” and “grouping” of query results are used to address this information overload problem. However, both ranking and grouping individually have shortcomings. With regard to grouping, each group may still be very large, thus the information overload problem continues to persist. With regard to ranking, globally high ranking results may all come from the same group, thus the end user may not be aware of the rest of the groups found in the search.

Therefore, it would be beneficial to have an improved computer implemented method, system, and computer usable program code for combining ranking and “clustering” of data during a database query to obtain a more precise search result.

### SUMMARY OF THE INVENTION

Illustrative embodiments provide a computer implemented method, system, and computer usable program code for combining ranking and clustering of data in a query search. A bitmap index is built from user input over each attribute in a database. In response to receiving a data query, bit vectors associated with the bitmap index are intersected on Boolean selection attributes resulting in a vector. A clustering summary grid is constructed by intersecting the bit vectors on clustering attributes. The vector is intersected with the clustering summary grid to obtain a filtered clustering grid. A clustering algorithm is applied on the filtered clustering grid to obtain one or more clusters of data. Vectors associated with buckets in each of the one or more clusters are intersected resulting in one vector for each of the one or more clusters. A ranking summary grid is constructed by intersecting the bit vectors on ranking attributes contained in the query. The vector is intersected with the ranking summary grid to obtain a filtered ranking grid. The one vector for each of the one or more clusters is intersected with the filtered ranking grid to obtain a modified grid. Buckets in the modified grid are pruned according to a lower-bound and an upper-bound of each bucket in the modified grid and a top predetermined number to obtain candidate buckets that contain the top predetermined number of data in a cluster. The top predetermined number of data are retrieved in the candidate buckets. A ranking score is calculated for each of the top predetermined number of data. The top predetermined number of data are sorted according to ranking scores. Then, a result is returned for the query that contains the top predetermined number of the data according to the ranking scores.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram illustrating components of a server device and a client device in accordance with an illustrative embodiment;

FIG. 4 is an exemplary illustration of a cluster-rank query in accordance with an illustrative embodiment;

FIG. 5 is an exemplary illustration of integrating Boolean, clustering, and ranking in accordance with an illustrative embodiment;

FIG. 6 is a flowchart illustrating an exemplary process for returning a result for a cluster-rank query in accordance with an illustrative embodiment;

FIG. 7 is an exemplary illustration of a clustering algorithm in accordance with an illustrative embodiment; and

FIG. 8 is an exemplary illustration of a ranking algorithm in accordance with an illustrative embodiment.

### DETAILED DESCRIPTION OF THE PREFERRED EMBODIMENT

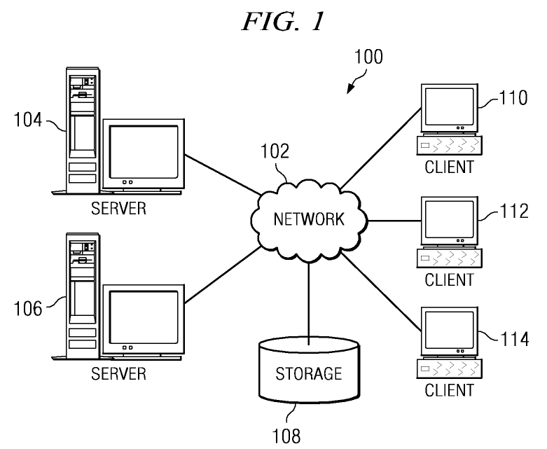

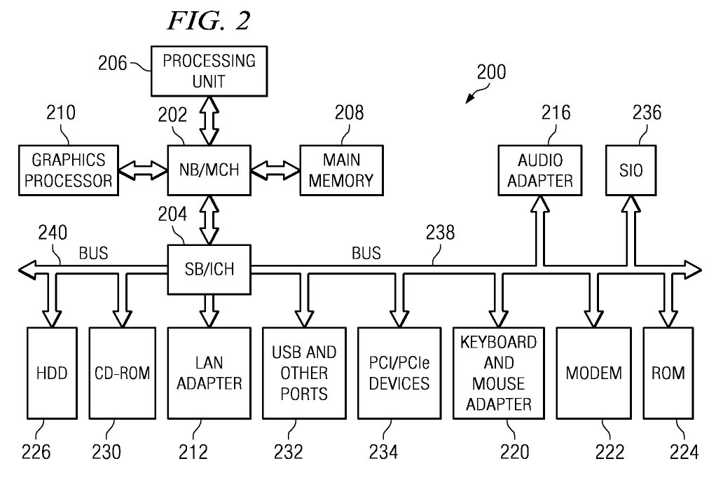

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between computers and other various devices connected together within network data processing system 100. Network 102 may include connections, such as wire, wireless communication links, or fiber optic cables.

In the depicted example, server 104 and server 106 connect to network 102, along with storage unit 108. In addition, clients 110, 112, and 114 also connect to network 102. Clients 110, 112, and 114 may, for example, be personal computers or network computers. In the depicted example, server 104 provides data, such as boot files, operating system images, and applications to clients 110, 112, and 114. Clients 110, 112, and 114 are clients to server 104 in this example. Furthermore, network data processing system 100 also may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

Storage 108 may, for example, be a relational database. The data contained within storage 108 may be of any type and may be stored in one or more tables. However, it should be noted that storage 108 may store this data in either a structured format or an unstructured format.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to NB/MCH 202. Processing unit 206 may contain one or more processors and may even be implemented using one or more heterogeneous processor systems. Graphics processor 210 may be coupled to NB/MCH 202 through an accelerated graphics port (AGP), for example.

In the depicted example, local area network (LAN) adapter 212 is coupled to SB/ICH 204 and audio adapter 216, keyboard and mouse adapter 220, modem 222, read only memory (ROM) 224, universal serial bus (USB) and other ports 232, and PCI/PCIe devices 234 are coupled to SB/ICH 204 through bus 238, and hard disk drive (HDD) 226 and CD-ROM 230 are coupled to SB/ICH 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). HDD 226 and CD-ROM 230 may, for example, use an integrated drive electronics (IDE) or serial advanced technology attachment (SATA) interface. A super I/O (SIO) device 236 may be coupled to SB/ICH 204.

An operating system runs on processing unit 206 and coordinates and provides control of various components within data processing system 200 in FIG. 2. The operating system may be a commercially available operating system such as Microsoft® Windows® XP. Microsoft and Windows are trademarks of Microsoft Corporation in the United States, other countries, or both. An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as HDD 226, and may be loaded into main memory 208 for execution by processing unit 206. The processes of the illustrative embodiments may be performed by processing unit 206 using computer implemented instructions, which may be located in a memory such as, for example, main memory 208, ROM 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in NB/MCH 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Illustrative embodiments provide a computer implemented method, system, and computer usable program code for combining ranking and clustering of data in a query search. A bitmap index is built offline from user input over each attribute in a database. In response to receiving a data query online, bit vectors associated with the bitmap index are intersected on Boolean selection attributes resulting in a vector. A clustering summary grid is constructed by intersecting the bit vectors on clustering attributes. The vector is intersected with the clustering summary grid to obtain a filtered clustering grid. A clustering algorithm is applied on the filtered clustering grid to obtain one or more clusters of data. Vectors associated with buckets in each of the one or more clusters are intersected resulting in one vector for each of the one or more clusters.

A ranking summary grid is constructed by intersecting the bit vectors on ranking attributes contained in the query. The vector is intersected with the ranking summary grid to obtain a filtered ranking grid. The one vector for each of the one or more clusters is intersected with the filtered ranking grid to obtain a modified grid. Buckets in the modified grid are pruned according to a lower-bound and an upper-bound of each bucket in the modified grid and a top predetermined number to obtain candidate buckets that contain the top predetermined number of data in a cluster.

The top predetermined number of data are retrieved in the candidate buckets. A ranking score is calculated for each of the top predetermined number of data. The top predetermined number of data are sorted according to ranking scores. Then, a result is returned for the query that contains the top predetermined number of the data according to the ranking scores.

Thus, illustrative embodiments integrate ranking and clustering with the Boolean semantic of SQL. Illustrative embodiments define a new type of query, the cluster-rank query, which groups the results that satisfy the Boolean conditions into a number of clusters based on given clustering attributes and then obtains the top predetermined number of results within each cluster according to a given ranking function that involves some ranking attributes. In addition, illustrative embodiments use a bitmap index to construct a query-dependant data summary of search results and then illustrative embodiments conduct clustering and ranking over the query-dependent data summary. In contrast to currently known solutions, illustrative embodiments are able to leverage the advantages of both ranking and grouping.

Consequently, given a database with a star-schema, where the star-schema includes a fact table and a set of dimension tables that are connected by keys and foreign keys, and given a cluster-rank query, which includes some Boolean selection and join conditions, a simple ranking function (weighted-sum) over a set of ranking attributes, a set of clustering attributes, a predetermined number of desired clusters, and a top predetermined number of desired tuples, illustrative embodiments provide a search result that includes a set of tuples that satisfy the Boolean conditions, which are grouped into the predetermined number of desired clusters having the top predetermined number of desired tuples within each cluster.

Illustrative embodiments generalize a “crisp” grouping to a “fuzzy” grouping, which is termed “clustering” in this specification. With input of attributes and a result size of a predetermined number, the clustering process outputs the predetermined number of clusters that best partition the space according to how objects are “similar” within the clusters, instead of strict equality of values. For the input specification, end users simply specify the desired number of clusters, much like the desired result size, and illustrative embodiments automatically weigh in the data distribution to generate the desired number of clusters. Further, as the grouping criteria, clustering forms partitions by data distribution. In other words, similar objects that do not share strictly identical values in attributes may still be grouped.

Illustrative embodiments implement this generalization from grouping to clustering for supporting data retrieval with SQL. Illustrative embodiments utilize k-means as the clustering scheme. A k-means algorithm is an algorithm to cluster objects based on attributes into a predetermined number of partitions. The algorithm starts by partitioning the input points into the predetermined number of initial sets, either at random or using some heuristic data. Then, the k-means algorithm calculates the mean point, or centroid, of each set. The k-means algorithm constructs a new partition by associating each point with the closest centroid. Subsequently, the centroids are recalculated for the new clusters and the algorithm is repeated by alternate application of these two steps until convergence, which is obtained when the points no longer switch clusters or when centroids are no longer changed. However, it should be noted that illustrative embodiments are not limited to using k-means. Illustrative embodiments may employ other distance-based clustering methods, as long as the distance or similarity functions are based on the proximity of attribute values.

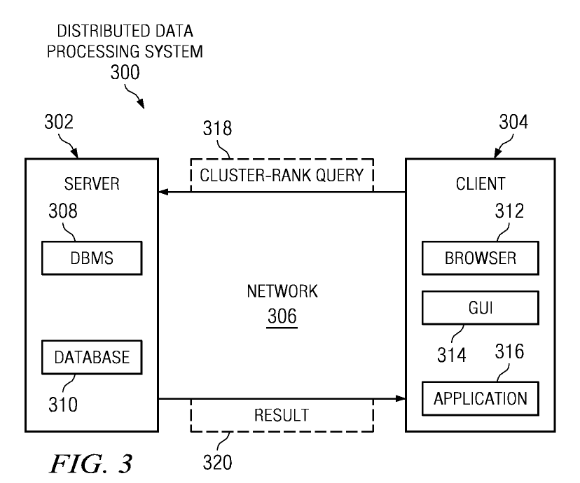

With reference now to FIG. 3, a block diagram illustrating components of a server device and a client device is depicted in accordance with an illustrative embodiment. Distributed data processing system 300 may, for example, be implemented in network data processing system 100 in FIG. 1. Distributed data processing system 300 includes server 302 and client 304, which are coupled together via network 306. For example, network data processing system 100 includes server 104 and client 110 that are connected together via network 102 in FIG. 1.

Server 302 includes database management system (DBMS) 308 and database (DB) 310. DBMS 308 is a software application that provides controls for the organization, storage, retrieval, security, and integrity of data in a database, such as database 310. Although database 310 is depicted within server 302, database 310 may reside in another server, such as server 106 in FIG. 1, or within a storage unit, such as storage 108 in FIG. 1. In addition, even though database 310 is illustrated as a single database, database 310 may represent a plurality of databases. Furthermore, database 310 comprises a set of related files that may include any type of data.

Client 304 includes browser 312, graphical user interface (GUI) 314, and application 316. An end user utilizes browser 312 to connect client 304 with server 302 via network 306. Client 304 uses GUI 314 to provide a means for the end user to interact with browser 312 and application 316. Application 316 is a software application designed to request information from database 310. In addition, application 316 may be any type of software application that is capable of performing processes of illustrative embodiments.

The end user uses browser 312 to send cluster-rank query 318 from application 316 to DBMS 308 via network 306. Cluster-rank query 318 is a database query that integrates Boolean selection attributes and join conditions, clustering attributes, and ranking attributes over the search to obtain a more precise query result. DBMS 308 receives cluster-rank query 318 and retrieves the appropriate data from database 310 according to cluster-rank query 318. Subsequent to retrieving the appropriate data according to cluster-rank query 318, DBMS 308 returns result 320 to client 304 via network 306. After client 304 receives result 320, the end user may view result 320 in GUI 314.

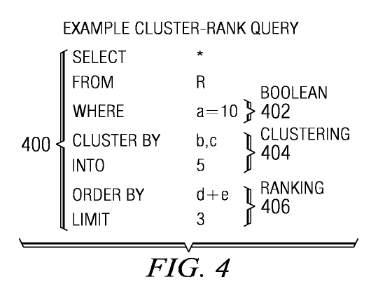

With reference now to FIG. 4, an exemplary illustration of a cluster-rank query is depicted in accordance with an illustrative embodiment. Cluster-rank query 400 may, for example, be cluster-rank query 318 in FIG. 3. Cluster-rank query 400 includes Boolean selection attributes 402, clustering attributes 404, and ranking attributes 406.

In this example, Boolean selection attributes 402 tell illustrative embodiments where to retrieve the appropriate data from within a database, such as, for example, database 310 in FIG. 3, to obtain a relation of qualifying tuples. Clustering attributes 404 tell illustrative embodiments how to cluster the retrieved data into the predetermined number of clusters, which in this example is five. Ranking attributes 406 tell illustrative embodiments how to rank or order the retrieved data and limit the data to the top predetermined number of tuples, which in this case is three.

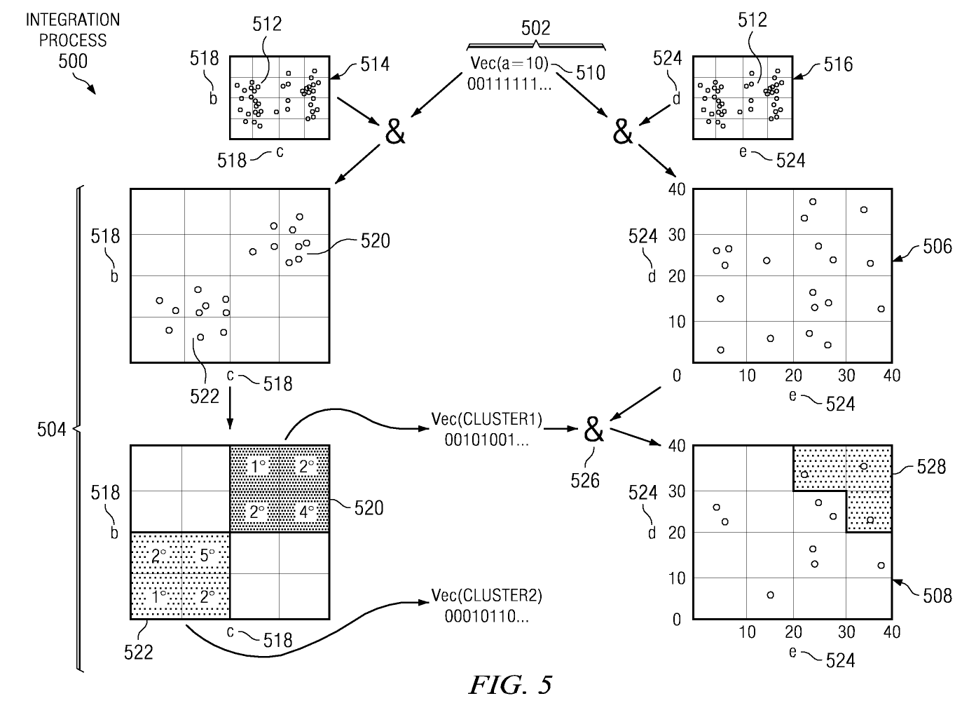

With reference now to FIG. 5, an exemplary illustration of integrating Boolean, clustering, and ranking is depicted in accordance with an illustrative embodiment. Integration process 500 integrates Boolean process 502, clustering process 504, and ranking process 506 to obtain result 508. Result 508 may, for example, be result 320 in FIG. 3. Illustrative embodiments implement integration process 500 in, for example, a DBMS, such as DBMS 308 in FIG. 3. An end user defines Boolean process 502, clustering process 504, and ranking process 506 in a cluster-rank query, such as, for example, cluster-rank query 318 in FIG. 3.

Boolean process 502 includes Boolean selection attributes 510. Boolean selection attributes 510 may, for example, be Boolean selection attributes 402 in FIG. 4. Boolean selection attributes 510 obtain relation of qualifying tuples 512. Illustrative embodiments construct clustering summary grid 514 and ranking summary grid 516 over relation of qualifying tuples 512.

Clustering process 504 includes clustering attributes 518, which in this example are “b” and “c”. Clustering attributes 518 may, for example, be clustering attributes 404 in FIG. 4. Illustrative embodiments cluster qualifying tuples 512 into cluster 520 and cluster 522. Both cluster 520 and cluster 522 include four virtual buckets that contain their respective qualifying tuples. Then, illustrative embodiment determine the centroid of each virtual bucket within cluster 520 and cluster 522.

Ranking process 506 includes ranking attributes 524, which in this example are “d” and “e”. Ranking attributes 524 may, for example, be ranking attributes 406 in FIG. 4. Illustrative embodiments rank qualifying tuples 512 based on a ranking function.

Subsequently, illustrative embodiments combine the results of clustering process 504 and ranking process 506 at point 526. Also, it should be noted that illustrative embodiments may simultaneously perform clustering process 504 and ranking process 506. By combining the results of clustering process 504 and ranking process 506, illustrative embodiments produce result 508. Illustrative embodiments limit result 508 by a predetermined number, which in this example is three. Shaded area 528 represents the predetermined number of three in this example. Illustrative embodiments return all tuples in shaded area 528 to the requesting client device, such as, for example, client 304 in FIG. 3, for an end user to review as the result of the query search.

As a result, illustrative embodiments support clustering and ranking together, with the order-within-groups semantics, as a generalization of “group-by” and “order-by” to support fuzzy data retrieval applications. Illustrative embodiments utilize summary-based clustering and ranking by using a dynamically constructed data summary, which incorporates Boolean selections and join conditions at query time. Illustrative embodiments implement this framework by utilizing a bitmap index to construct such data summaries on-the-fly and to integrate Boolean filtering, clustering, and ranking.

The semantics of the cluster-rank query is to perform three basic steps. The first step is the filtering process. Upon a base relation or Cartesian product of base relations, illustrative embodiments apply a Boolean selection function resulting in a relation of qualifying tuples. The second step is the clustering process. Tuples within the relation of qualifying tuples are partitioned into a predetermined number of clusters based on clustering attributes. The third step is the ranking process. A ranking, or scoring, function defined over a set of ranking attributes assigns a ranking score to each tuple. Within each cluster, the top predetermined number of tuples with the highest scores, or all tuples if there are less than the predetermined number of tuples in the cluster, are returned. When there are ties in scores, an arbitrary deterministic “tie-breaker” may determine an order, for example, by unique tuple identification number.

Presently in relational databases, no SQL syntax supports such queries, nor can On Line Analytical Processing (OLAP) functions express such queries. In essence, cluster-rank semantics are based on the concept of fuzzy clustering. Thus, illustrative embodiments require that partitions have fuzzy boundaries and specify the total number of clusters, as in k-means. Borrowing the syntax of SQL, illustrative embodiments denote fuzzy clustering by “group by . . . into . . . ” and integrate it with the “order by . . . limit . . . ” clause.

In other words, a cluster-rank query is a query augmented with clustering and ranking conditions. The query consists of a set of tables, a Boolean function over a set of attributes, a set of clustering attributes, a number limiting the total number of clusters, a ranking function or scoring function over the ranking attributes, and a number limiting the top tuples to retrieve within each cluster. However, it should be noted that the above syntax is only for illustration purposes and is not intended as a limitation on illustrative embodiments.

Up to this point in the discussion, only one semantic for cluster-rank queries has been used. That is, returning a top predetermined number of tuples within each cluster, which may, for example, be termed “global clustering/local ranking.” However, illustrative embodiments may extend the cluster-rank query model to embrace a richer set of semantics tailored for various application needs. For example, “local clustering/global ranking” is where the clustering process is only performed over the global top predetermined number of tuples instead of the total relation of qualifying tuples. Another example may be “global clustering/global ranking” where within each cluster, only those tuples that belong to the global top predetermined number of tuples, instead of the local top predetermined number of tuples, are returned. Moreover, illustrative embodiments may further allow ranking of the clusters by aggregate functions. However, the focus in this specification is on “global clustering/local ranking.”

If two tuples are close enough to each other, the clustering process assigns the two tuples to the same cluster. Illustrative embodiments use the grid-based data summary to put similar tuples into the same “bucket” and cluster at the bucket-level. To be more specific, illustrative embodiments perform partitioning (or binning) on each clustering attribute. The intersection of the bins over the clustering attributes provides the summary grid with the buckets. If two tuples fall into the same bucket, that is the two tuples fall into the same bin along each clustering attribute, illustrative embodiments may consider the two tuples as the “same” tuple, (i.e., inseparable). Thus, a bucket is the smallest unit in a cluster. As long as the bucket size is appropriate, the quality of clustering on the buckets is comparable to clustering on the original tuples. However, bucket-level clustering is much more efficient than tuple-level clustering since the number of buckets is much smaller than the number of tuples.

Illustrative embodiments use a summary grid for the ranking process as well. For each cluster, the summary grid for the tuples in the cluster is constructed over the ranking attributes. For the tuples in each bucket, an upper-bound and a lower-bound of their scores may be computed based on the boundaries of the corresponding bins on individual attributes. The bounds enable illustrative embodiments to prune those buckets that do not contain any of the top predetermined number of tuples. The top predetermined number of tuples in the unpruned candidate buckets are guaranteed to be the top predetermined number of tuples among all the tuples.

The clustering process and the ranking process operate on two orthogonal summary grids built over clustering and ranking attributes, respectively. It should be noted that the summary grids are query dependent since different queries may have different clustering and ranking attributes. Also, illustrative embodiments process the Boolean conditions before the clustering process and the ranking process are performed. Thus, illustrative embodiments must integrate Boolean filtering, clustering, and ranking in an efficient manner.

Consequently, illustrative embodiments use a bitmap index to meet this challenge of integrating Boolean filtering, clustering, and ranking. A bitmap index uses a vector of bits to indicate the membership of tuples for one value or one value range on an attribute. By intersecting the bit vectors for the bins over the individual clustering attributes, illustrative embodiments construct the clustering summary grid without going through all the tuples. Similarly, the ranking summary grid is constructed in much the same way. In summary, the bit vectors serve as the building block in unifying Boolean filtering, clustering, and ranking through the following steps: 1) bit vectors are used to process the Boolean conditions; 2) the resulting bit vectors are used in building the clustering summary grid; 3) clustering is performed on the summary grid; 4) the resulting bit vectors corresponding to each cluster are used in constructing the ranking summary grid; and 5) ranking is performed within each cluster.

Illustrative embodiments may utilize tables that have a snowflake-schema, which consists of one fact table and multiple dimension tables. In addition, there are multiple dimensions, each of which are described by a hierarchy, with one dimension table for each node on the hierarchy. The fact table is connected to the dimensions by foreign keys. The tables on each dimension are also connected by keys and foreign keys. A special case of a snowflake-schema is a star-schema, which only has one table on every dimension, thus no hierarchy.

Also, illustrative embodiments may utilize a k-means clustering algorithm. The clustering algorithm utilized by an illustrative embodiment clusters buckets, or virtual tuples, instead of real tuples. Therefore, illustrative embodiments take into consideration the weights, or number of tuples, of the virtual tuples, or buckets. The clustering algorithm may simply be adjusted to consider such weights.

The bitmap index is an efficient indexing structure. A bitmap index over an attribute consists of a set of bit vectors, one vector per unique value of the attribute. The length of each bit vector equals the number of tuples, which is the cardinality of the indexed relation. As a bucket in the summary grid represents the intersections of the corresponding ranges, illustrative embodiments may obtain the members in a bucket by intersection of the bit vectors for the ranges.

Using the summary grid, illustrative embodiments are able to efficiently cluster search results. The key idea is to cluster the buckets in the data summary and assign the tuples in the same bucket to the same cluster. Given a set of tuples to be clustered and clustering attributes, illustrative embodiments obtain the summary grid using the clustering attributes as the partitioning attributes.

Associated with each bucket is a virtual point, or centroid, located at the center of the bucket. Illustrative embodiments approximate the tuples in the bucket as a set of identical tuples at the virtual point, where the number of identical tuples is equal to the cardinality of the bucket. Such an approximation is based on the intuition that the tuples inside the same bucket are close enough to each other, if the grid is fine-grained enough, so that the differences in tuples may be ignored without introducing significant impact on the clustering result.

Illustrative embodiments apply clustering on the virtual points. The clustering algorithm used by illustrative embodiments takes into consideration the weight of each virtual point. The weight of a virtual point is the cardinality of the corresponding bucket. For example, when a virtual point of a bucket with a predetermined number of tuples is inserted into a cluster, the clustering algorithm updates the centroid of the cluster as if that same number of identical points are inserted.

Using such adaptation, the clustering algorithm of illustrative embodiments continues for multiple rounds, as centroids are updated and virtual points are reassigned, until the clusters converge. At the end of the clustering process, the virtual points (i.e., the buckets and, thus, the corresponding original tuples) are grouped into the predetermined number of clusters. The union of vectors for buckets in the same cluster provides the members in that cluster.

During construction of the summary grid, illustrative embodiments dispose of empty intermediate buckets before vectors from all the attributes are intersected. More generally, illustrative embodiments prune buckets, whose cardinality is under certain threshold (i.e., underpopulated buckets that likely will result in many empty buckets if they further intersect with the remaining attributes). The pruned buckets do not participate in clustering. After clustering the non-pruned buckets in the summary grid, illustrative embodiments use random access to retrieve tuples belonging to the pruned buckets. The identification numbers of these pruned tuples may be obtained by bit-negation of the union of vectors for all the clusters. Then, illustrative embodiments assign the pruned tuples to their closest clusters, whose vectors are modified by setting the bits corresponding to the pruned tuples.

Clearly, summary-based clustering has advantages over the prior art as only one virtual point is needed for a large number of tuples in the same bucket. Thus, the number of virtual points may be much smaller than that of the original number of tuples. This reduction of data size by illustrative embodiments not only saves CPU overhead in assigning tuples to clusters, but more importantly also saves the I/O overhead in scanning the tuples from base tables or intermediate relations. Moreover, such a summary-based method allows illustrative embodiments to seamlessly integrate clustering and ranking.

Illustrative embodiments also use the summary grid structure in the ranking process as well. The key idea is that illustrative embodiments prune most of the tuples that are outside of the top predetermined number of tuples and focus on the candidate tuples determined by the upper-bound and the lower-bound score of the tuples within each bucket. For each bucket, such upper and lower bounds are derived from the corresponding ranges of the partitioning attributes on the bucket.

Given a set of tuples to be ranked and a ranking function over the ranking attributes, illustrative embodiments obtain the summary grid using the ranking attributes as the partitioning attributes. The bit vector for each bucket in the grid is obtained by intersecting the bit vectors corresponding to the ranges on the ranking attributes. The resulting bit vectors for each bucket provide illustrative embodiments with the tuple identification numbers within each bucket. Moreover, by counting the set bits in a vector, illustrative embodiments may obtain the cardinality of the corresponding bucket. In addition to the cardinality, illustrative embodiments may obtain the upper-bound and lower-bound scores for tuples in each bucket. Therefore, given a bucket, the highest or lowest possible score of each tuple in that bucket is reached when the values of ranking attributes equal the right or left endpoints of the corresponding ranges on these ranking attributes.

Based on the upper-bounds and lower-bounds of the buckets, illustrative embodiments may derive a set of candidate buckets that are guaranteed to contain all the top predetermined number of tuples in the summary grid. Correspondingly, the rest of the buckets may be safely pruned as the tuples in those buckets are guaranteed to be ranked lower than the top predetermined number of tuples. By performing a union of vectors for the candidate buckets, illustrative embodiments may thus retrieve tuples in the candidate buckets to obtain exact scores for the tuples. The top predetermined number of tuples in these candidate buckets form the top predetermined number of tuples in the summary grid as well.

However, it should be noted that tuples to be clustered are actually the result of Boolean conditions (i.e., the relation of qualifying tuples). Therefore, before illustrative embodiments construct the summary grid, the vectors over the clustering attributes must take into consideration the filtering effects of the Boolean conditions. If a tuple does not belong to the relation of qualifying tuples, the corresponding bits in the vectors are set to zero. Bit vector operations smoothly allow such processing of clustering together with Boolean conditions. Further, by utilizing a snowflake-schema, processes of illustrative embodiments may be easily extended to handle join queries.

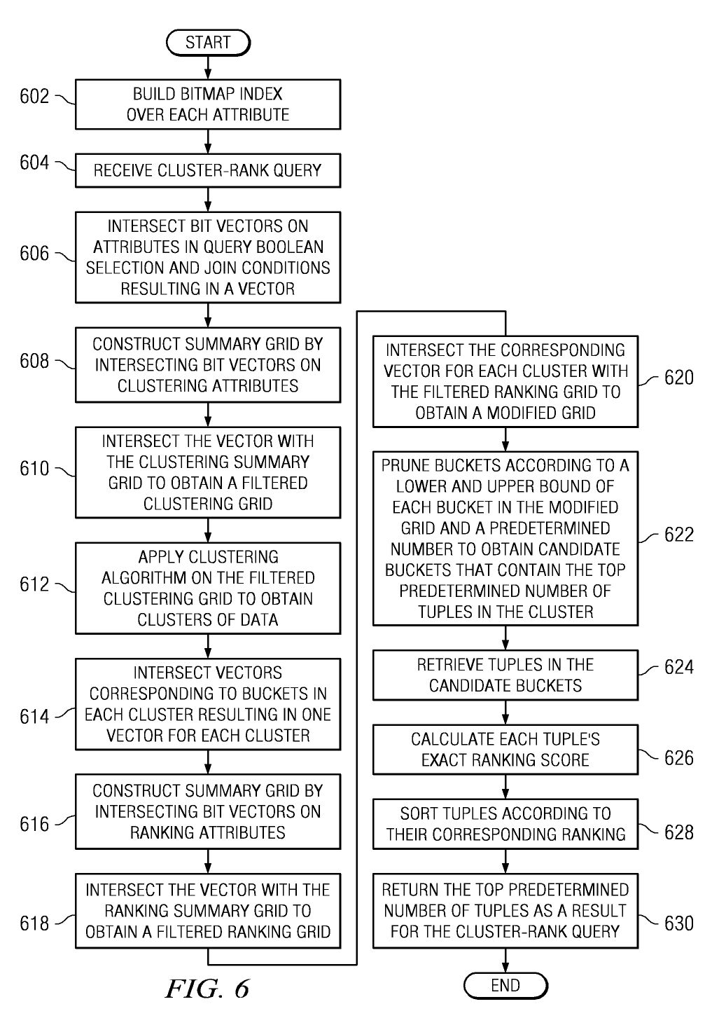

With reference now to FIG. 6, a flowchart illustrating an exemplary process for returning a result for a cluster-rank query is shown in accordance with an illustrative embodiment. The process shown in FIG. 6 may be implemented in a DBMS, such as, for example, DBMS 308 in FIG. 3.

The process begins when an end user, such as, for example, a system administrator, builds a bitmap index over each attribute in a database, such as, for example, database 310 in FIG. 3, off-line using the DBMS (step 602). Subsequently, the DBMS receives a cluster-rank query from a client device via a network to search the database for specified data (step 604). For example, DBMS 308 receives cluster-rank query 318 from client 304 via network 306 in order to obtain data from database 310 in FIG. 3.

After receiving the cluster-rank query in step 604, the DBMS intersects bit vectors associated with the bitmap index on Boolean selection attributes contained in the cluster-rank query, such as, for example, Boolean selection attributes 402 contained in cluster-rank query 400 in FIG. 4, and join conditions, which result in a vector (step 606). Then, the DBMS constructs a clustering summary grid, such as clustering summary grid 514 in FIG. 5, by intersecting the bit vectors on clustering attributes contained in the cluster-rank query, such as clustering attributes 518 in FIG. 5 (step 608). Afterward, the DBMS intersects the vector resulting from step 606 with the clustering summary grid to obtain a filtered clustering grid (step 610). Subsequently, the DBMS applies a clustering algorithm on the filtered clustering grid to obtain clusters of qualifying tuples (step 612). Each cluster is a set of buckets, or virtual tuples, in the filtered clustering grid. The DBMS intersects vectors corresponding to buckets in each cluster, which results in one vector for each cluster of qualifying tuples (step 614).

Then, the DBMS constructs a ranking summary grid, such as ranking summary grid 516 in FIG. 5, by intersecting the bit vectors on ranking attributes contained in the cluster-rank query, such as ranking attributes 524 in FIG. 5 (step 616). However, it should be noted that step 616 may be executed concurrently with step 608. Afterward, the DBMS intersects the vector resulting from step 606 with the ranking summary grid to obtain a filtered ranking grid (step 618). Subsequently, the DBMS intersects the corresponding vector for each cluster with the filtered ranking grid to obtain a modified grid (step 620). The DBMS prunes buckets in the modified grid according to an upper-bound and a lower-bound of each bucket in the modified grid and a top predetermined number of tuples to obtain candidate buckets that contain the top predetermined number of tuples in the cluster (step 622).

Then, the DBMS retrieves the top predetermined number of tuples in the candidate buckets (step 624) and calculates each tuple's exact ranking score (step 626). Afterward, the DBMS sorts the top predetermined number of tuples according to their corresponding ranking (step 628). Subsequently, the DBMS returns a result, such as result 320 in FIG. 3, which includes the top predetermined number of tuples listed according to their corresponding ranking, to the client device via the network (step 630). An end user using the client device may view and interact with the result as desired. The process terminates thereafter.

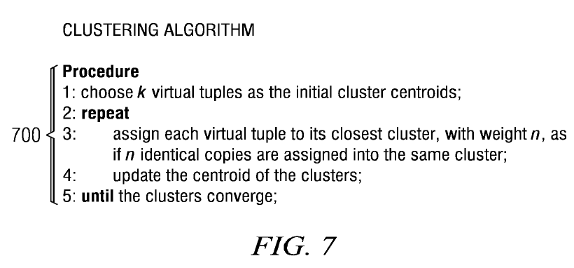

With reference now to FIG. 7, an exemplary illustration of a clustering algorithm is depicted in accordance with an illustrative embodiment. Illustrative embodiments may locate exemplary clustering algorithm 700 within, for example, a DBMS, such as DBMS 308 in FIG. 3. However, illustrative embodiments are not limited to locating clustering algorithm 700 within the DBMS. Illustrative embodiments may locate clustering algorithm 700 within any component of the data processing system that is capable of storing clustering algorithm 700. Alternatively, clustering algorithm 700 may reside in a network device coupled to the data processing system utilizing clustering algorithm 700.

Also, it should be noted that clustering algorithm 700 is only intended as an example of one type of clustering algorithm that may be utilized by illustrative embodiments. In other words, illustrative embodiments are not restricted to the use of clustering algorithm 700. Any algorithm capable of accomplishing clustering processes of an illustrative embodiment may be used.

Clustering algorithm 700 begins by choosing the top predetermined number of virtual tuples as the initial cluster centroids. Then, clustering algorithm 700 repeats assigning each virtual tuple to its closest cluster, with a weight number, as if the weighted number of identical copies are assigned into the same cluster. Finally, clustering algorithm 700 updates the centroid of the clusters until the clusters converge.

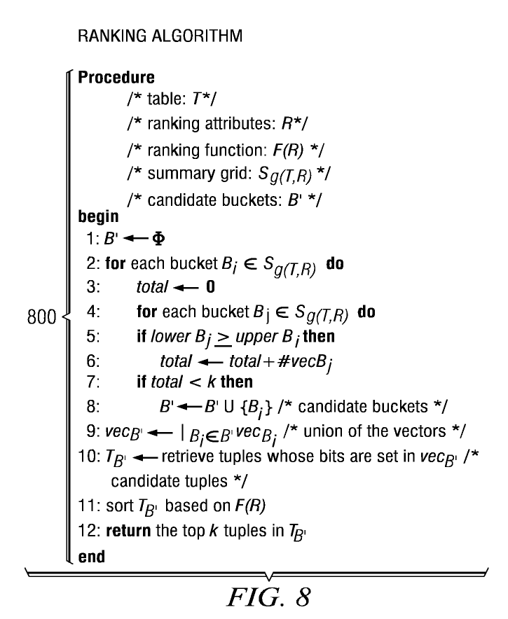

With reference now to FIG. 8, an exemplary illustration of a ranking algorithm is depicted in accordance with an illustrative embodiment. Illustrative embodiments may locate exemplary ranking algorithm 800 within, for example, a DBMS, such as DBMS 308 in FIG. 3. However, illustrative embodiments are not limited to locating ranking algorithm 800 within the DBMS. Illustrative embodiments may locate ranking algorithm 800 within any component of the data processing system that is capable of storing ranking algorithm 800. Alternatively, ranking algorithm 800 may reside in a network device coupled to the data processing system utilizing ranking algorithm 800.

Also, it should be noted that ranking algorithm 800 is only intended as an example of one type of ranking algorithm that may be utilized by illustrative embodiments. In other words, illustrative embodiments are not restricted to the use of ranking algorithm 800. Any algorithm capable of accomplishing ranking processes of illustrative embodiments may be used.

Ranking algorithm 800 begins by pruning buckets of tuples obtained by Boolean filtering. Ranking algorithm 800 prunes the buckets in the summary grid of the obtained tuples according to the lower and upper bounds of each bucket to obtain candidate buckets. After obtaining the candidate buckets, ranking algorithm 800 performs a union of the vectors for the candidate buckets. Then, ranking algorithm 800 retrieves candidate tuples whose bits are set in the union of the candidate buckets' vector. Afterward, ranking algorithm 800 sorts the candidate tuples based on a ranking function and returns the top predetermined number of tuples.

Thus, illustrative embodiments provide a computer implemented method, system, and computer usable program code for combining ranking and clustering of candidate tuples in a database query search. The invention may take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system. For the purposes of this description, a computer-usable or computer-readable medium may be any tangible apparatus that may contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a ROM, a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, et cetera) may be coupled to the system either directly or through intervening I/O controllers.

Network adapters also may be coupled to the system to enable the data processing system to become coupled to other data processing systems, remote printers, or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for combining ranking and clustering of data in a query search, the computer implemented method comprising:
building a bitmap index over each attribute in a database;
responsive to receiving a query for data from the database, intersecting bit vectors associated with the bitmap index on Boolean selection attributes contained in the query resulting in a vector;
constructing a clustering summary grid by intersecting the bit vectors on clustering attributes contained in the query;
intersecting the vector with the clustering summary grid to obtain a filtered clustering grid;
applying a clustering algorithm on the filtered clustering grid to obtain one or more clusters of the data;
intersecting vectors associated with buckets in each of the one or more clusters resulting in one vector for each of the one or more clusters;
constructing a ranking summary grid by intersecting the bit vectors on ranking attributes contained in the query;
intersecting the vector with the ranking summary grid to obtain a filtered ranking grid;
intersecting the one vector for each of the one or more clusters with the filtered ranking grid to obtain a modified grid;
pruning the buckets in the modified grid according to a lower-bound and an upper-bound of each bucket in the modified grid and a top predetermined number to obtain candidate buckets that contain the top predetermined number of the data in a cluster;
retrieving the top predetermined number of the data in the candidate buckets;
calculating a ranking score for each of the top predetermined number of the data;
sorting the top predetermined number of the data according to ranking scores; and
returning a result for the query that contains the top predetermined number of the data according to the ranking scores.

2. The computer implemented method of claim 1, wherein the building, intersecting, constructing, applying, pruning, retrieving, calculating, sorting, and returning steps are performed by a database management system.

3. The computer implemented method of claim 1, wherein the query is a cluster-rank query.

4. The computer implemented method of claim 3, wherein the cluster-rank query includes the Boolean selection attributes, the clustering attributes, and the ranking attributes.

5. The computer implemented method of claim 1, wherein the data is a set of tuples.

6. The computer implemented method of claim 1, wherein the Boolean selection attributes also include join conditions.

7. A computer program product for combining ranking and clustering of data in a query search, the computer program product comprising:
a computer usable medium having computer usable program code embodied therein, the computer usable medium comprising:
computer usable program code configured to build a bitmap index over each attribute in a database;
computer usable program code configured to intersect bit vectors associated with the bitmap index on Boolean selection attributes contained in the query resulting in a vector in response to receiving a query for data from the database;
computer usable program code configured to construct a clustering summary grid by intersecting the bit vectors on clustering attributes contained in the query;
computer usable program code configured to intersect the vector with the clustering summary grid to obtain a filtered clustering grid;
computer usable program code configured to apply a clustering algorithm on the filtered clustering grid to obtain one or more clusters of the data;
computer usable program code configured to intersect vectors associated with buckets in each of the one or more clusters resulting in one vector for each of the one or more clusters;
computer usable program code configured to construct a ranking summary grid by intersecting the bit vectors on ranking attributes contained in the query;
computer usable program code configured to intersect the vector with the ranking summary grid to obtain a filtered ranking grid;
computer usable program code configured to intersect the one vector for each of the one or more clusters with the filtered ranking grid to obtain a modified grid;
computer usable program code configured to prune the buckets in the modified grid according to a lower-bound and an upper-bound of each bucket in the modified grid and a top predetermined number to obtain candidate buckets that contain the top predetermined number of the data in a cluster;
computer usable program code configured to retrieve the top predetermined number of the data in the candidate buckets;
computer usable program code configured to calculate a ranking score for each of the top predetermined number of the data;
computer usable program code configured to sort the top predetermined number of the data according to ranking scores; and
computer usable program code configured to return a result for the query that contains the top predetermined number of the data according to the ranking scores.
